(19) United States
(12) Patent Application Publication
(10) Pub. No.: US 2003/0106405 A1
(43) Pub. Date: Jun. 12, 2003

(54) Device for the extraction of signatures from a folding apparatus

(76) Inventors: Manfred Wolfang Hartmann, Elfershausen (DE); Horst Bernhard Michalik, H?ouml;chberg (DE)

Correspondence Address: Douglas R Hanscom, Jones Tullar & Cooper, P O Box 2266 Eads Station, Arlington, VA, 22202, US

(21) Appl. No.: 10/240,763

(22) PCT Filed: Apr. 6, 2001
(86) PCT No.: PCT/DE01/01347

(30) Foreign Application Priority Data
Apr. 15, 2000 (DE) 100187706

(51) Int. Cl. B26D 7/06; B26D 1/62

(52) U.S. Cl. 83/155; 83/157; 83/346

(57) ABSTRACT

The invention relates to a device for the extraction of signatures (19), or similar, from a folding apparatus (2), whereby the paper is extracted by means of an optionally switchable guide (39) arranged on a cylinder. Furthermore, the folding apparatus (2) is connected to a comminuting device (56).

The invention relates to devices for the extraction of signatures or a beginning of a web or a web ribbon from a folding apparatus, according to the preamble to claim 1 or 4.

DE 21 26 610 A discloses a folding apparatus with a waste paper shunt, in which a transport cylinder has point needles and deflectors.

DE 43 01 093 A1 discloses a device for extracting test samples in a folding apparatus. In it, points are disposed on a grooved cylinder, which cooperate with a stationary stripper.

The object of the invention is to produce devices for the extraction of signatures or a beginning of a web or a web ribbon from a folding apparatus.

This object is attained according to the invention by means of the features of claim 1 or 4.

The advantages that can be achieved with the invention are comprised particularly in that a removal of webs or paper webs in the form of cut ribbon sections or signatures occurs, which are easier to handle than wound webs. In addition, the signatures are automatically supplied to an extraction system for disposal, sorted according to whether they are printed or unprinted. It is also possible to supply an uncut web ribbon to the extraction system. Consequently, for example, a web infeed all the way into the folding apparatus can be carried out automatically without the paper web speed having to be reduced. A manual winding-on of a paper web before the folding apparatus entry can be eliminated.

Other achievable advantages are that when feeding paper webs into a folding apparatus, individual paper webs before the entry into a folding cylinder group no longer have to be manually disposed of, but instead, the paper webs are conveyed away cut into signatures. This occurs until all the paper webs of the paper web ribbon are together at the entry to the folding apparatus and can subsequently be transversely folded all at once.

Together with a paper diversion apparatus, the device can also be used in the event of malfunctions of the folding system in the cylinder folding group or of the delivery belt so that a known paper ribbon rejection system before the entry into the cylinder folding group can be eliminated.

Several exemplary embodiments of the invention are shown in the drawings and will be explained in detail below.

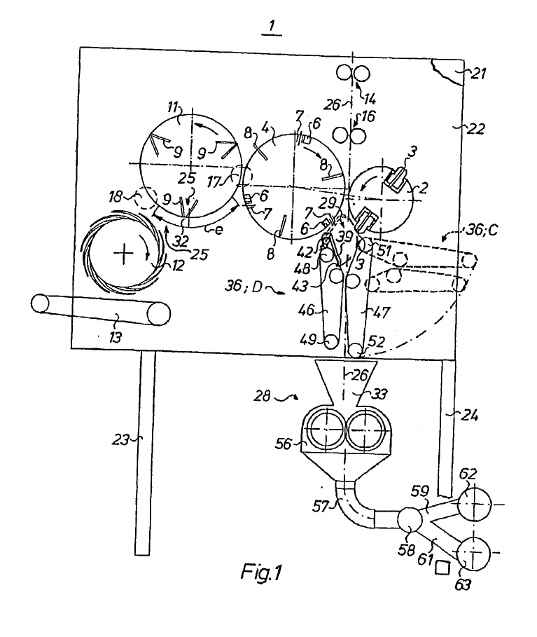

FIG. 1 schematically depicts a cross section through the cylinder group of a folding apparatus with a device;

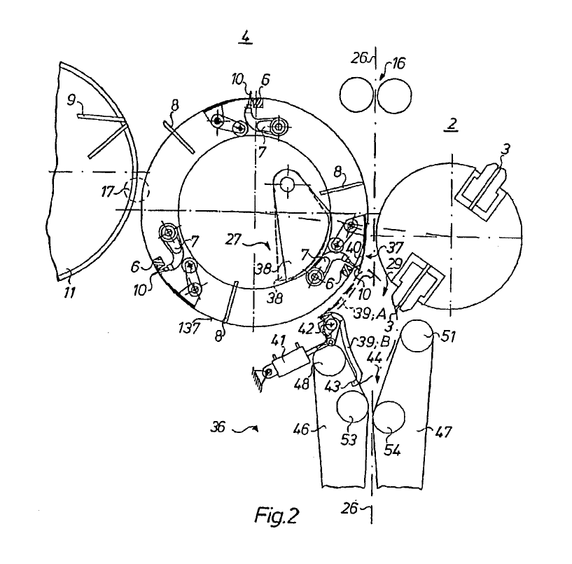

FIG. 2 gives an enlarged depiction of the delivery device, guide, and entry into the grasping-and transporting apparatus;

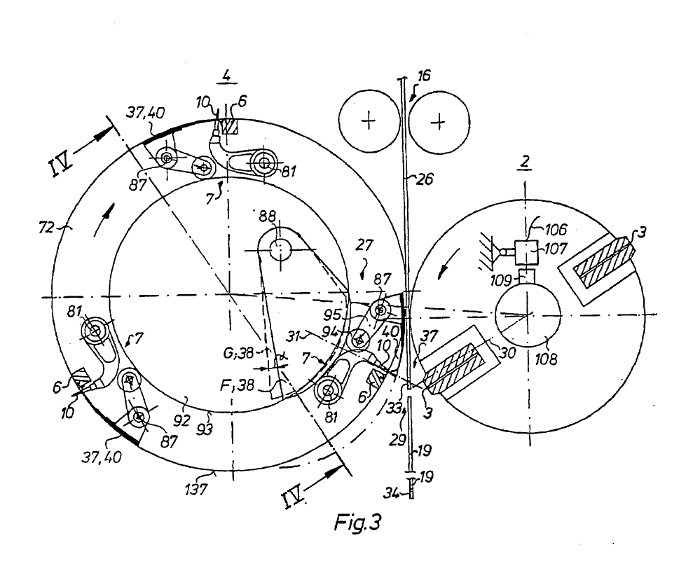

FIG. 3 gives a detailed depiction of a drive mechanism of the delivery device;

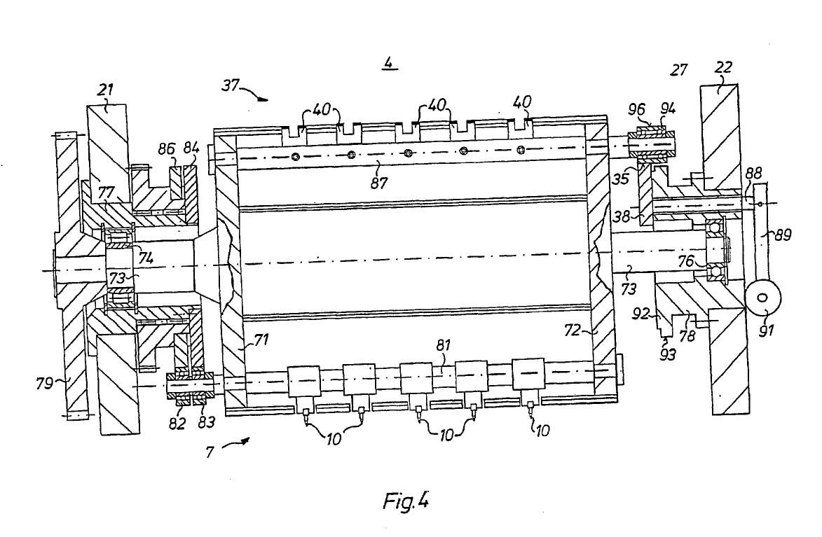

FIG. 4 shows a section along the line IV-IV according to FIG. 3;

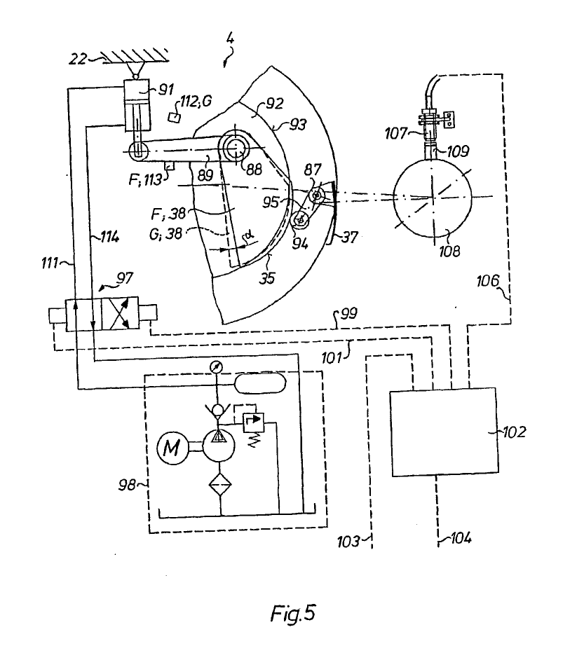

FIG. 5 shows a cutout detail of the drive mechanism and the control unit of a stripping device according to FIGS. 2 or 3;

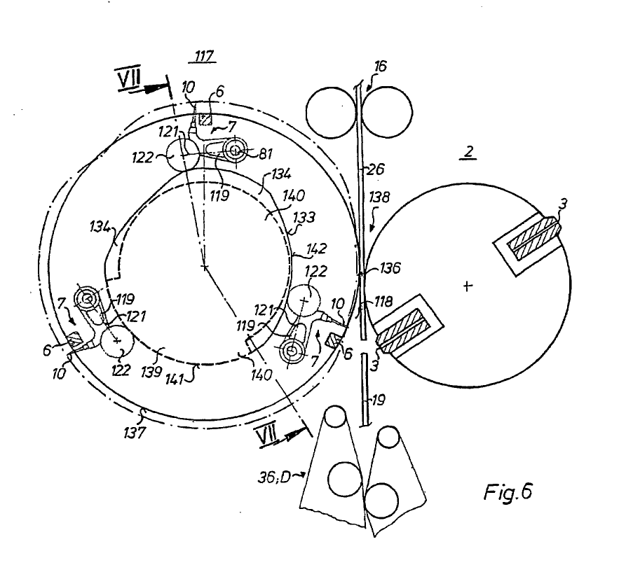

FIG. 6 gives an enlarged depiction of a cutting cylinder and a point- and counterpart cutting strip cylinder with another embodiment variant of a delivery device for the extraction of a signature;

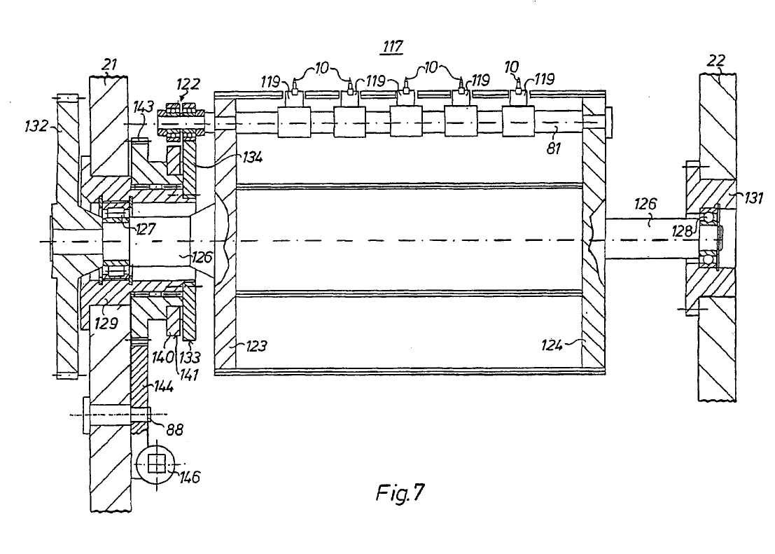

FIG. 7 shows a section along the line VII-VII according to FIG. 6;

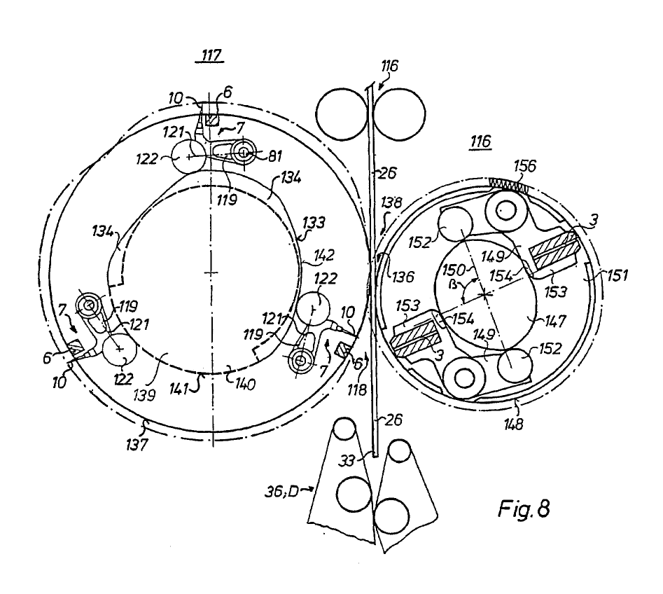

FIG. 8 shows an enlarged depiction of a cutting cylinder and a point- and counterpart cutting strip cylinder with another embodiment variant of a device for the extraction of a paper web.

A cylinder folding group of a folding apparatus 1 of a web-fed rotary printing press is comprised, for example, of a two-field cutting blade cylinder 2, which has cutting blades 3 and cooperates with a three-field transport cylinder or a counterpart cutting strip- and collecting cylinder 4. The collecting cylinder 4 has counterpart cutting strips 6, grasping mechanisms or holding elements, e.g. controlled point systems 7 with point needles 10 and folding blades 8.

The collecting cylinder 4 cooperates with a three-field folding jaw cylinder 11 that has controlled folding jaw systems 9.

The folding jaw cylinder 11 is followed by a delivery fan 12 and a delivery belt 13. The folding apparatus 1 can also be differently embodied. For example, the counterpart cutting strip- and collecting cylinder 4 can also be embodied as a five-field or seven-field cylinder with a corresponding folding jaw cylinder 11 associated with it.

The transverse cutting device, which is comprised of the cutting blade cylinder 2 and transport cylinder 4, e.g. the collecting cylinder 4, is preceded by two known draw roller pairs 14; 16. In the vicinity of their circumferences, the collecting cylinder 4 and the folding jaw cylinder 11 have paper guiding devices, not shown, which are comprised, for example, of guide rails spaced apart from each other in the production direction.

The cylinder folding group 2; 4; 11 and the delivery fan 12 are supported in side frames 21, 22. The side frames 21; 22 can be placed on machine frames 23; 24 disposed underneath them.

A device for handling and in particular for diverting a web or material web, e.g. a paper web or a paper web ribbon 26 comprised of several paper webs 26, before or after a transfer point 17, 18 for signatures 19, has a switchable delivery device 27 or 25 to a disposal apparatus 28. The transfer point 17 for signatures 19 is disposed in a nip between cylinder 4 and cylinder 11 and the transfer point 18 is disposed between the cylinder 11 and the delivery fan 12.

The switchable delivery device 27 can be disposed on the circumference of the cylinder 2 or 4 and the delivery device 25 can be disposed on the cylinder 11 and both of the delivery devices can be actuated by means of control devices.

The delivery device 27 cannot function in the cutting region of the cylinder 2; 4 or in the vicinity of the transfer points 17; 18. The delivery device 27 is preferably actuated in the vicinity of the exit nip 29 of the cylinder 2; 4; i.e. before the transfer point 17 at a release point 31 or after the transfer point 18 in a region e at a release point 32. The delivery device 25 in this case is comprised of a folding jaw system 9 controlled in this region e. At the release point 31 of the cylinder 4 (FIG. 3) or 32 of cylinder 11 (FIG. 1), the respective holding devices 7 and 9 are inoperative so that the beginning 33 of the paper web ribbon 26 or the beginning 34 of the signatures 19 is conveyed to a switchable ribbon- or signature-grasping- and transporting apparatus 36.

In the case of the cylinder 4, the holding devices are comprised of point systems 7. The delivery device 27 of the cylinder 4 is embodied as a stripping device 37 for the needles of the point systems 7. In terms of the production rotation direction of the cylinder 4, the stripping devices 37 are respectively disposed after the point systems 7 and are comprised of retracting devices 40, which encompass the point needles 10 in a fork-shaped, i.e. partial, fashion. The retracting devices 40 can also completely encompass the point needles 10, e.g. if the retracting devices 40 have bores through which the point needles 10 protrude.

These stripping devices 37 are connected to a pivotable cam segment 38, which is affixed to the side frames and can be pivoted into and out of position. In the event of an extraction, the signatures 19, i.e. the paper web 26 transversely cut into pieces, are shunted downward from the point needles 10 of the point systems 7 by means of the retracting devices 40 of the stripping device 37 and are conveyed to the disposal apparatus 28 (FIG. 1).

Between the stripping device 27 and the ribbon- or signature-grasping- and transporting apparatus 36, a guide 39 or switchable shunt is advantageously disposed spaced apart at the circumference of the collecting cylinder 4 and can be pivoted into a rest position A—depicted with dashed lines—or into a working position B.

The guide 39 is comprised, for example, of a part of the paper guide device close to the exit nip 29 of the transverse cutting device 2; 4. The guide 39 is actuated, for example, by means of pneumatic working cylinders 41 (FIG. 2) and can be pivoted around a pivot axis 42 into the above-mentioned positions A; B.

In the working position B, the ends 43 of the guides 39 remote from the pivot axis cooperate with a wedge-shaped, tapering entry nip 44 between two concurrently operating endless belt systems 46; 47 of the ribbon- or signature-grasping- and transporting apparatus 36. The belt systems 46; 47 are respectively guided over deflecting rollers 48; 49; 51; 52 and guide rollers 53; 54, and the deflecting rollers 49; 52 are driven, for example, by means of motors. The two belt systems 46; 47 are disposed, for example, in a frame that is not shown. This frame can be pivoted by means of the drive mechanism that is not shown, e.g. pneumatic working cylinders, from a horizontal rest position C—depicted with dashed lines—into a vertical working position D around a pivot axle 42 affixed to the side frames (FIG. 1).

As will be demonstrated below, the point systems 7 passing through the exit nip 29 of the transverse cutting device 2; 4 can also be temporarily retracted as needed.

It is naturally also possible to use other grasping means, e.g. gripper systems, in lieu of the point systems.

It is also possible to dispose the above-mentioned grasping means 7 on the circumference of the cutting blade cylinder 2 and to suspend their operation in the event of an extraction in the vicinity of a release point 30.

Signatures 19 are transversely cut and possibly previously longitudinally folded sections of a paper web ribbon 26 or a paper web.

The disposal apparatus 28 is comprised of a known chopping mechanism 56. The signatures 19 masticated there are supplied by means of an air suction-carrying conduit 57, possibly by means of a conduit shunt 58, to another conduit 59 or 61, either to a delivery point 62 for white paper remnants or a delivery point 63 for printed paper remnants.

The machine control station can act on the conduit shunt 58 by means of a signal to select its position, e.g. for “pressure off ” or “pressure on”,

In lieu of situating a chopping mechanism 56 after it, the output of the ribbon- or signature-grasping- and transporting apparatus 36 can also be associated with vertically situated conduits and subsequent conveyor belts for transporting the signatures 19 to one or alternatively several collecting receptacles. This can take place for both unprinted and printed signatures.

A method for handling a paper web beginning or a signature 19 takes place as follows: If, for example, new paper webs 26 are being fed into a web-fed rotary printing press, then the paper webs 26 arrive one after the other and possibly individually before the entry to the transverse cutting device 2; 4 of the folding apparatus 1. The beginnings 33 of the paper webs 26 are continuously supplied to the transverse cutting device 2; 4 with grasping mechanisms 7; by means of the guide 39 or shunt, which is disposed in the working position B, and with the aid of the retraction device 40 of the stripping device 37, are supplied to the belt systems 46; 47 disposed in the working position D, i.e. are diverted from the otherwise usual production process. Generally speaking, first the beginning of the paper web ribbon 26 is gripped or pinned by the grasping means, e.g. point systems 7, of the cylinder 4 and is transported. For example, before the transfer point 17 of the signatures 19 to the folding jaw cylinder 11 and in the exit nip 29 of the transverse cutting device 2; 4, the beginning 33 of the paper web or of the paper web ribbon 26 is released by the point systems 7, e.g. by means of a delivery device 27, and is then supplied to the belt systems 46; 47 of the disposal apparatus 28.

If the release point 31 lies outside the exit nip 29 of the transverse cutting device 2; 4, and at least in the vicinity of the transfer point 17, then the signatures 19 are diverted at that point.

If the machine control station sends a signal, then the delivery device 27 executes its function by changing the position of the cam segment 38 and the shunt or guide 39.

The ribbon- or signature-grasping- and transporting apparatus 36 assumes its rest position C and the belt systems 46; 47 are pivoted into their rest position C. The signatures 19 then travel in the usual manner through the folding apparatus 1.

If malfunctions occur during the course of production, then the devices 27; 36 can be made operational again. The same is true when new paper webs are fed in.

The collecting cylinder 4 has end plates 71; 72 at its ends, which are affixed to a shaft 73. The shaft 73 is supported in a freely rotating fashion at both ends by means of bearings 74; 76 and bearing bushes 77; 78 affixed to the side frames and can be driven by means of a gear 79 (FIG. 4). The end plates 71; 72 have three point shafts 81 distributed over their circumference, which support the respective point systems 7 with the point needles 10. Alternatively, five or seven point shafts 81 can also be provided. Each point shaft 81 is connected by means of a lever arm, not shown, and rollers 82; 83 to a known cam 84 for point systems 7 affixed to the side frames, and to a cam 86—a so-called covering disk—which is rotatably supported on the bearing bush 77 and can be driven by means of a transmission.

Preceding the point systems 7 in terms of the rotation direction of the cylinder 4, stripping devices 37 that encompass the point needles 10 in a fork-shaped fashion according to the invention are disposed on a hollow shaft 87, which is affixed to the end plates and contains a torsion spring. The segment-shaped cam segment 38, which is affixed to the side frames and can be pivoted by an angular amount Alpha from a rest position G to a working position F, is disposed at the release point 31 provided for the retraction, e.g. in the exit nip 29 of the transverse cutting device 2; 4. By means of a shaft 88, which is guided by the bearing bush 78 in a direction axially parallel to the shaft 73, and a lever arm 89, the cam segment 38 is connected to a hydraulically operated working cylinder 91 that is affixed to the side frames.

At its end remote from the end plate, the bearing bush 78 has a cylindrical cam 92 disposed coaxial to the shaft 73, with a circular control surface 93 on its circumference. A roller 94 with a double-width running surface 96 revolves against this control surface 93. The term “double-width” means that the running surface 96 is connected both to the control surface 93 and to the control surface 35 of the cam segment 38. The roller 94 is connected to the hollow shaft 87 by means of a lever arm 95.

The working cylinder 91 is embodied so as to be double-acting and is connected by means of a control valve 97 to a pressure supply station 98 (FIG. 5). The pressure supply station 98 includes, for example, a hydraulic pump, a pressure regulator, a check valve, a hydraulic reservoir, and a measuring device. The control valve 97 is in turn connected by means of control lines 99; 101 to a control unit 102, which is in turn connected by means of lines 103; 104 to a computer or control station and is also connected by means of a line 106 to a sensor 107 affixed to the side frame. The sensor 107 detects the respective position of the cutting blade 3 by means of a cam 109 resting against the shaft 108 of the cylinder 2.

The computer or control station sends signals to the control unit 102 by means of the lines 103; 104. Consequently, the working cylinder 91 is supplied with hydraulic fluid by means of the control valve 97 and a line 111 so that the cam segment 38 is moved from the rest position G to the working position F. The deflection of the lever arm 89 and consequently of the cam segment 38 is limited by stops 112:113 affixed to the side frames.

Through a rotation of the cam segment 38 by an angular amount Alpha, e.g. of 5°, the control surface 35 of the cam segment 38 slides against the control surface 93 of the cam 92 (FIG. 5). By means of the double-width roller 94, the lever arm 95 is then lifted as it rolls over the control surface 35 and in so doing, the retracting device 40 of the stripping device 37 is also lifted up. As a result, the beginning 33 of the paper web ribbon 26 is lifted up by the point needles 10 of the point systems 7, is diverted from the cylinder 4, and is supplied to the disposal apparatus 28.

In the process of rolling against the control surface 93, the double-width roller 94 already has a particular speed, which is advantageously only increased by a negligible amount as it travels over the control surface 35 of the cam segment 38.

If a signal for good signatures 19 is sent from the computer or control station via the line 103; 104 to the control unit 102 and a signal of the sensor 107 conforms with this signal, then the working cylinder 91 is supplied with hydraulic fluid via the control valve 97 and a line 114, as a result of which the cam segment 38 is moved into the rest position G.

This assures that only complete products, i.e. signatures 19, are transferred to the cylinders of the folding apparatus 1 and the additional processing apparatuses.

According to another embodiment variant, a device for handling, extracting, or redirecting of signatures 19 or a beginning 33 of a paper web 26 or a paper web ribbon is comprised, for example, of releasable grasping mechanisms, e.g. of retractable point systems 7. The point systems 7 are disposed on the collecting cylinder 4 of the first cylinder pair 2; 117 and are disposed so that they can be retracted inside the circumference 137 of the collecting cylinder 117, at least in the vicinity of an exit nip 118, by means of a point system control mechanism 81, 119, 121, 122, 134, 140 (FIG. 6).

As a result, the signatures 19 can be extracted from the usual production process after they pass through the exit nip 118 disposed between the cutting blades cylinder 2 and the collecting cylinder 117 (FIG. 6). To that end, the cutting blade cylinder 2 has for example two cutting blades 3 on its circumference, as described above.

The point needles 10 are held in respective point needles holders 119 disposed on a point shaft 81. A roller lever 121 affixed to each point shaft 81 supports a double-width roller 122 at its end.

Two end plates 123; 124 adjoin the collecting cylinder 117 on a shaft 126. The shaft 126 is supported in a freely rotating fashion at both ends by means of bearings 127; 128 and bearing bushes 129; 131 affixed to the side frames and can be driven by means of a gear 132 (FIG. 7).

On one side, the roller 122 travels on a control surface 133 of the cam 134 affixed to the side frame. The control surface 133 is embodied, i.e. flattened, so that in the vicinity of a nip 136 between the cutting blade cylinder 2 and the collecting cylinder 117, the tips of the point needles 10 can be retracted inside the circumference 137 of the collecting cylinder 117.

In the vicinity of the nip 136 means in the vicinity of an entry nip 138 and of the exit nip 118 of the cutting blade cylinder 2 and the collecting cylinder 117.

Consequently, the signatures 19 cut by means of the cutting blade 3 and the counterpart cutting strip 6 can be supplied as needed to a ribbon- or signature-grasping- and transporting apparatus 36 and/or a disposal apparatus 28, i.e. can be separated out.

If the point needles 10 need to protrude out again from the circumference 137 of the collecting cylinder 117 in the vicinity of the nip 136 in order to be able to transport the signatures 19 further, then the drivable covering disk 140 (FIG. 6) is rotated approx. 90° counterclockwise, which then covers a flattened region 142 of the control surface 133 with a raised area 139 in its control surface 141. The covering disk 140 is affixed to the rotatable bearing bush 129, which supports a toothed ring 143. A rotation of the covering disk 140 is produced by means of a gear segment 144, which is pivotably affixed to the side frame and can be moved into two positions by means of a working cylinder 146.

In lieu of the point systems 7, it is naturally also possible to use other grasping means, e.g. gripper systems.

In order to support the extraction effect of a beginning 33 of a web 26, the cutting blades 3 on the cutting blade cylinder 2 or 116 can be retracted inside the circumference 148 of the cutting blade cylinder 116, at least in the vicinity of the nip 136. In the depiction according to FIG. 8, both the point needles 10 of the cylinder 117 and the cutting blades 3 of the cutting blade cylinder 116 are retracted in the vicinity of the nip 136.

The beginning 33 of the web 26 and thereafter, consequently, the entire web 26 can be supplied to the ribbon- or signature-grasping- and transporting apparatus 36 and/or the disposal apparatus 28.

A control body 147, which is connected to the side frame 21 or 22, is oval in cross section for example, and can rotate on the shaft of a cutting blade cylinder 116, is provided in order to retract the cutting blades 3 in the vicinity of the nip 136. This control body 147 can be rotated by means that are not shown, for example working cylinders, by an angle Beta, e.g. of 90°, in relation to the outer cutting blade cylinder 116 so that the vertical axis 150 of the cross-sectionally oval control body 147 no longer points in the direction of the rollers 152 as shown in FIG. 8, but points in the direction of the cutting blades 3. Depending on the position of the control body 147, the cutting blades 3 are either inside the circumference 148 of the cutting blade cylinder 116 (FIG. 8) or in the normal position that is not shown, i.e. outside the circumference 148, when they are in the vicinity of the nip 136.

The cutting blades 3 are supported at both ends by means of two-armed elbow levers 149 that are supported in the end plates 151. There can be several elbow levers 149 per cutting blade 3.

A first side of the elbow lever 149 supports a roller 152 and a second side of the elbow lever 149 supports the cutting blade 3 in a cutting blade holder 153. The side of the cutting blade holder 153 oriented away from the cutting edge of the cutting blade 3 has a friction reducing antifriction layer 154, with which the cutting blade 153 is supported on the surface of the control body 137.

In a suitable manner, the cutting blade cylinder 116 has brushes 156 on its casing or circumference 148, which are used to press the paper web ribbon 26 against the counterpart cutter strip- and collecting cylinder 117.

### REFERENCE NUMERAL LIST

01 folding apparatus

02 cutting blade cylinder (1)

03 cutting blade (2)

04 collecting cylinder (1)

05 -

06 Counterpart cutting strip (4)

07 holding device; point system (4)

08 folding blade (4)

09 holding device; folding jaw system (11)

10 point needle (7)

11 folding jaw cylinder (1)

12 delivery fan

13 delivery belt

14 draw roller pair

15 -

16 draw roller pair

17 transfer point (4; 11)

18 transfer point (II; 12)

19 signature

20 -

21 side frame

22 side frame

23 machine frame

24 machine frame

25 delivery device (11)

26 paper web ribbon, web

27 delivery device (4)

28 disposal apparatus

29 exit nip (2; 4)

30 release point (2)

31 release point (4)

32 release point (11)

33 beginning (26)

34 beginning (19)

35 control surface (38)

36 ribbon- or signature-grasping- and transporting apparatus

37 stripping device (7)

38 cam segment (37)

39 guide, shunt

40 retracting device (37)

41 working cylinder (39)

42 pivot axis (39)

43 end (39)

44 entry gap (46; 47)

45 -

46 belt system

47 belt system

48 deflecting roller (46)

49 deflecting roller (46)

50 -

51 deflecting roller (47)

52 deflecting roller (47)

53 guide roller (46)

54 guide roller (47)

55 -

56 chopping mechanism

57 conduit

58 conduit shunt

59 conduit

60 -

61 conduit

62 delivery point

63 delivery point

64 to 70 -

71 end plate (4)

72 end plate (4)

73 shaft (4)

74 bearing (73)

75 -

76 bearing (73)

77 bearing bush (73)

78 bearing bush (73)

79 gear (73)

80 -

81 point needle shaft (7)

82 roller (81)

83 roller (81)

84 cam (7)

85 -

86 cam

87 hollow shaft (37)

88 shaft (89)

89 lever arm (91)

90 -

91 working cylinder (38)

92 cam

93 control surface (92)

94 roller

95 lever arm (94)

96 running surface (94)

97 control valve

98 pressure supply station

99 control line

100 -

101 control line

102 control unit

103 line

104 line

105 -

106 line

107 sensor

108 shaft (2)

109 cam (108)

110 -

111 line (91)

112 stop (89)

113 stop (89)

114 line (91)

115 -

116 cutting blade cylinder

117 collecting cylinder

118 exitnip (116, 117; 2, 117)

119 point needle holder (10)

120 -

121 roller lever

122 roller (121)

123 end plate (117)

124 end plate (117)

125 -

126 shaft (117)

127 bearing

128 bearing

129 bearing bush (127)

130 -

131 bearing bush (128)

132 gear (126)

133 control surface (134)

134 cam

135 -

136 nip (2, 117; 116, 117)

137 circumference (117)

138 entry nip

139 raised area (141)

140 covering disk

141 control surface (140)

142 flattened region (133)

143 toothed ring

144 gear segment

145 -

146 working cylinder (144)

147 control body (116)

148 circumference (116)

149 elbow lever (116)

150 vertical axis (147)

151 end plate (116)

152 roller (116)

153 cutting blade holder

154 antifriction layer (153)

155 -

156 brush

A rest position (39)

B working position (39)

C rest position (36)

D working position (36)

G rest position (38)

F working position (38)

e region

Alpha angular amount (G; F)

Beta angle

1. A device for the extraction of signatures (19) or a beginning (33) of a web (26) or a web ribbon from a folding apparatus (2, 4, 11), wherein a shunt (39) of a transporting apparatus (36) is associated with a cylinder (4 or 11) of the folding apparatus (2, 4, 11) and wherein the shunt (39) can be deliberately switched, characterized in that the shunt (39) is associated with at least one ribbon- or signature-grasping- and transporting apparatus (36) comprised of endless belt systems (46; 47).

2. The device according to claim 1, characterized in that the belt systems (46; 47) are disposed so that they can be pivoted from a rest position (C) into an extraction- or working position (D).

3. The device according to claim 1, characterized in that the shunt (39) and the transporting apparatus (36) are associated with a disposal apparatus (28, 56, 62, 63).

4. A device for the extraction of signatures (19) or a beginning (33) of a web (26) or a web ribbon from a folding apparatus (2, 4, 11), characterized in that the folding apparatus is associated with a masticating device (56).

5. The device according to claim 4, characterized in that the masticating device (56) is embodied as a chopping mechanism.

6. The device according to claim 4, characterized in that the masticating device (56) is disposed in the immediate vicinity of the folding apparatus.
